(19) United States
(12) Patent Application Publication
(10) Pub. No.: US 2019/0369623 A1
(43) Pub. Date: Dec. 5, 2019

(54) SELF-DRIVING VEHICLE

(71) Applicant: Honda Motor Co., Ltd., Tokyo (JP)

(72) Inventors: Masayuki Sadakiyo, Wako-shi (JP); Hisashi Ishikawa, Wako-shi (JP); Tomoyuki Noguchi, Wako-shi (JP); Takashi Adachi, Wako-shi (JP)

(21) Appl. No.: 16/409,262

(22) Filed: May 10, 2019

(30) Foreign Application Priority Data
May 30, 2018 (JP) 2018-103545

(51) Int. Cl. G05D 1/02; H04W 4/40; H04W 4/90

(52) U.S. Cl. CPC G05D 1/0214; G05D 1/0285; G05D 2201/0213; H04W 4/90; H04W 4/40

(57) ABSTRACT

A self-driving vehicle including an actuator used for traveling, a communication unit receiving disaster information and a microprocessor. The microprocessor is configured to perform controlling the actuator so as to evacuate the self-driving vehicle to a predetermined place when the disaster information is received by the communication unit, the actuator includes a shift actuator changing a speed ratio of a transmission. The microprocessor is configured to perform the controlling including controlling the shift actuator so as to increase the speed ratio of the transmission when the disaster information is received by the communication unit.

### CROSS-REFERENCE TO RELATED APPLICATION

This application is based upon and claims the benefit of priority from Japanese Patent Application No. 2018-103545 filed on May 30, 2018, the content of which is incorporated herein by reference.

### BACKGROUND OF THE INVENTION

### Field of the Invention

This invention relates to a self-driving vehicle capable of traveling in self-driving.

### Description of the Related Art

Conventionally, there is a known apparatus that autonomously drives a vehicle to a safe place on a shoulder when an earthquake or other disaster strikes. Such an apparatus is described in, for example, Japanese Unexamined Patent Publication No. 2010-20371 (JP2010-020371A). The apparatus described in JP2010-020371A is adapted to receive disaster occurrence information, thereafter detect a shoulder with adequate parking space, and then detect in self-drive mode to drive the vehicle to and stop it at the detected shoulder.

An important point in this regard is that when a disaster occurs, the vehicle is preferably safeguarded or evacuated as soon as possible. However, the apparatus of JP2010-020371A responds to disaster occurrence merely by switching vehicle drive mode to self-drive mode and then moving the vehicle to a safe place in this mode. Therefore, the apparatus of JP2010-020371A cannot easily achieve prompt safeguarding or evacuation of the vehicle to a safe place.

### SUMMARY OF THE INVENTION

An aspect of the present invention is a self-driving vehicle, including: a drive power source; a transmission installed in a power transmission path transmitting a torque from the drive power source to wheels; an actuator used for traveling; a communication unit configured to receive a disaster information; and an electric control unit including a microprocessor and a memory connected to the microprocessor. The microprocessor is configured to perform controlling the actuator so as to evacuate the self-driving vehicle to a predetermined place when the disaster information is received by the communication unit. The actuator includes a shift actuator changing a speed ratio of the transmission. Further, the microprocessor is configured to perform the controlling including controlling the shift actuator so as to increase the speed ratio of the transmission when the disaster information is received by the communication unit.

### BRIEF DESCRIPTION OF THE DRAWINGS

The objects, features, and advantages of the present invention will become clearer from the following description of embodiments in relation to the attached drawings, in which:

FIG. 1 is a diagram showing a configuration overview of a driving system of a self-driving vehicle according to an embodiment of the invention;

FIG. 2 is a block diagram schematically illustrating overall configuration of a vehicle control system controlling the self-driving vehicle of FIG. 1;

FIG. 3 is a diagram showing an example of a shift map stored in a memory unit of FIG. 2;

FIG. 4 is a block diagram illustrating main configuration of a vehicle control apparatus mounted on the self-driving vehicle according to the embodiment of the invention; and

FIG. 5 is a flowchart showing an example of processing performed by a controller of FIG. 4.

### DETAILED DESCRIPTION OF THE INVENTION

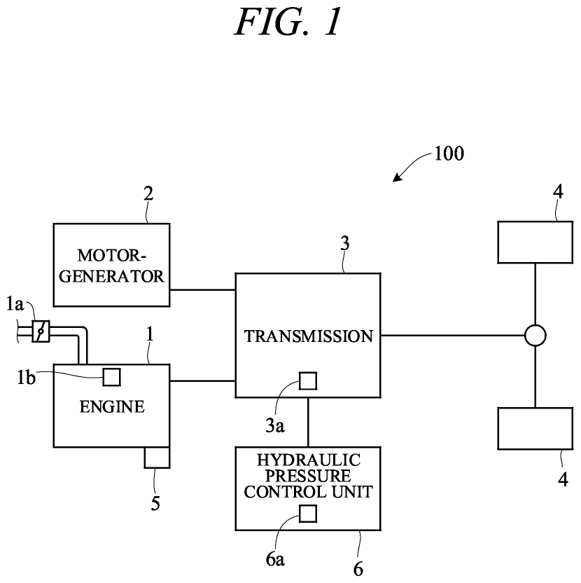

Hereinafter, an embodiment of the present invention is explained with reference to FIGS. 1 to 5. A self-driving vehicle according an embodiment of the present invention (hereinafter sometimes called simply “vehicle”) is adapted to enable the vehicle to be moved or evacuated to a predetermined place by self-driving when the vehicle receives information regarding disaster occurrence. Such disaster occurrence information includes both information on disasters already in progress and information on impending (predicted) disasters. These disasters include not only natural ones such as earthquakes, tsunamis, tornadoes, floods and landslides but also various other emergency events such as ballistic missile strikes.

FIG. 1 is a diagram showing a configuration overview of a driving system of a self-driving vehicle 100 with a self-driving capability according to an embodiment of the present invention. The vehicle 100 is not limited to driving in a self-drive mode requiring no driver driving operations but is also capable of driving in a manual drive mode by driver operations.

As shown in FIG. 1, the vehicle 100 includes an engine 1 and motor-generator 2 serving as driving power sources, and is configured as a hybrid vehicle. A transmission 3 is installed in a power transmission path between the engine 1, motor-generator 2 and wheels 4. The vehicle 100 travels by a torque transmitted from the engine 1 and motor-generator 2 to the wheels 4 through the transmission 3. Optionally, the vehicle 100 can be configured as an internal combustion vehicle by omitting the motor-generator 2, or as an electric vehicle by omitting the engine 1.

The engine 1 is an internal combustion engine (e.g., gasoline engine) wherein intake air supplied through a throttle valve and fuel injected from an injector are mixed at an appropriate ratio and thereafter ignited by a sparkplug or the like to burn explosively and thereby generate rotational power. A diesel engine or any of various other types of engine can be used instead of a gasoline engine. The vehicle 100 further includes a starter motor 5 driven by electric power supplied from an un-shown battery. A crankshaft is driven to rotate by the starter motor 5, and thus the engine 1 can be started. Optionally, the engine 1 can be started by power of the motor-generator 2 without using the starter motor 5.

The motor-generator 2 includes a rotatable rotor and stator installed around the rotor, and can function as a motor and as a generator. More specifically, the rotor of the motor-generator 2 is driven by electric power from a battery through an un-shown power control unit to a coil of the stator. In such case, the motor-generator functions as a motor. On the other hand, when a rotating shaft of the rotor of the motor-generator 2 is driven by an external force, the motor-generator 2 generates electric power that is applied through the power control unit to charge the battery. In such case, the motor-generator 2 functions as a generator.

The transmission 3 varies and outputs speed ratio of rotation of from the engine 1 and motor-generator 2, and converts and outputs torque from the engine 1 and motor-generator 2. The rotation of speed converted by the transmission 3 is transmitted to the drive wheels 4, thereby propelling the vehicle 100. The transmission 3 is, for example, a stepped transmission enabling stepwise speed ratio (gear ratio) shifting in accordance with multiple speed stages, and includes an input shaft to which a rotation from the engine 1 and motor-generator 2 is input and an output shaft from which a converted rotation is output. The speed ratio corresponds to a ratio of a rotational speed of the input shaft relative to a rotational speed of the output shaft, and decreases along with an increase of number of stages. Optionally, a continuously variable transmission enabling stepless speed ratio shifting can be used as the transmission 3. Although omitted in the drawings, power from the engine 1 can be input to the transmission 3 through a torque converter.

The transmission 3 can, for example, incorporate a dog clutch, friction clutch or other engaging mechanism 3a. A hydraulic pressure control unit 6 includes a solenoid valve, proportional solenoid valve or other control valve 6a operated by electric signal. The control valve 6a is driven by electric signal applied to the solenoid. The hydraulic pressure control unit 6 can shift speed stage of the transmission 3 by controlling flow of oil to the engaging mechanism 3a from a hydraulic pressure source in accordance with operation of the control valve 6a.

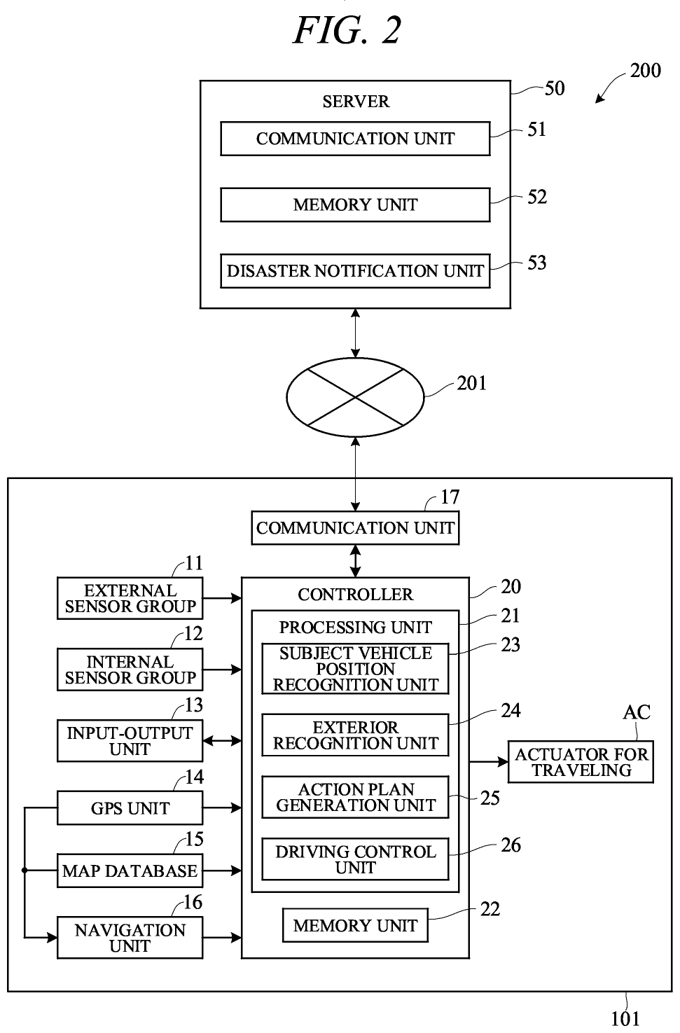

An opening angle of the throttle valve 1a, an amount of fuel injected from the injector 1b (injection timing and injection time), an operation of the motor-generator 2, an operation of the starter motor 5 and an operation of the control valve 6a are controlled by a controller 20 (FIG. 2) mounted on the vehicle 100.

FIG. 2 is a block diagram schematically illustrating overall configuration of a vehicle control system 200 for controlling a travel operation of the vehicle 100. As shown in FIG. 2, the vehicle control system 200 includes an onboard unit 101 mounted on the vehicle 100, and a server 50 capable of communicating with the onboard unit 101 through a communication network 201. The network 201 includes not only a public wireless communication network such as internet and mobile telephone network but also an exclusive communication network set in a predetermined service area, for example, a wireless LAN, Wi-Fi (registered trademark), Bluetooth (registered trademark), etc.

The server 50 is configured, for example, as a single server or as a distributed server composed of function-specific individual servers. Optionally, the server 50 can be configured as a distributed type server (including a virtual server) constructed in a cloud environment called a cloud server. The server 50 incorporates a computer including a CPU or other processing unit (a microprocessor) 21, a memory of RAM, ROM or the like, and other peripheral circuits. As functional configurations, the server 50 includes a communication unit 51, a memory unit 52 and disaster notification unit 53.

The communication unit 51 is configured to wirelessly communicate with the onboard unit 101 via the network 201 and to receive various kinds of emergency information (disaster information) from outside sources wirelessly or by wired connection. Emergency information received by the communication unit 51 includes, inter alia, emergency information distributed by the Conveyance of disaster information system (commonly called “L-Alert”), emergency warning signals distributed by the Emergency Warning System (abbreviated as “EWS”), emergency information distributed by the Emergency Alert and Warning System in Japan (commonly called “J-ALERT”), and emergency information distributed by the Emergency Net (commonly called “Em-Net”). Namely, the communication unit 51 receives both natural disaster information and emergency information regarding disasters other than natural ones. The communication unit 51 also acquires position information of the vehicle 100 from the onboard unit 101.

The memory unit 52 stores, in advance in association with predicted disaster scenarios, evacuation places (refuge areas) and typical and/or recommended evacuation routes to evacuation places for the vehicle located in a region apt to be damaged by a predicted type of disaster. The evacuation places are stored in association with type of natural disaster. For example, the parking lot of a large supermarket located on high ground might be stored in memory as a tsunami evacuation place. Optionally, evacuation routes can be calculated by the CPU of the server 50 (e.g., by an un-shown route calculation unit thereof) instead of being stored in the memory unit 52.

When the communication unit 51 receives emergency information of one or more kinds, i.e., disaster information, the disaster notification unit 53 uses position data of the subject vehicle 100 (and other similarly equipped vehicles also sometimes referred to as vehicles 100 herein) received through the communication unit 51 to identify which vehicles 100 should be sent disaster information. In other words, the disaster notification unit 53 identifies vehicles 100 located the region where vehicles need to be safeguarded or evacuated. The identified vehicles 100 are then transmitted disaster information utilizing telematics, for example. At this time, the disaster notification unit 53 uses the disaster information and position information of the vehicle 100 to access the memory unit 52 and decide evacuation place or places for the vehicles 100 located in the region where vehicles need to evacuate. In addition, the disaster notification unit 53 sends move-to-safety instructions including the decided evacuation place(s) through the communication unit 51 to the onboard unit 101 of each vehicle 100 concerned. The transmitted move-to-safety instruction includes route directions to the evacuation place(s).

Next, a configuration of the onboard unit 101 is explained. The onboard unit 101 includes mainly the controller 20, and as members communicably connected with the controller 20 through CAN (Controller Area Network) communication or the like, an external sensor group 11, an internal sensor group 12, an input-output unit 13, a GPS unit 14, a map database 15, a navigation unit 16, a communication unit 17, and actuators AC for traveling.

The term external sensor group 11 herein is a collective designation encompassing multiple sensors (external sensors) for detecting external circumstances constituting vehicle ambience data. For example, the external sensor group 11 includes, inter alia, a LIDAR (Light Detection and Ranging) for measuring distance from the vehicle 100 to ambient obstacles by measuring scattered light produced by laser light radiated from the vehicle 100 in every direction, a RADAR (Radio Detection and

Ranging) for detecting other vehicles and obstacles around the vehicle 100 by radiating electromagnetic waves and detecting reflected waves, and cameras having a CCD, CMOS or other image sensor and attached to the vehicle 100 for imaging ambience (forward, reward and sideways) of the vehicle 100.

The term internal sensor group 12 herein is a collective designation encompassing multiple sensors (internal sensors) for detecting driving state of the vehicle 100. For example, the internal sensor group 12 includes, inter alia, a vehicle speed sensor for detecting vehicle speed of the vehicle 100 and acceleration sensors for detecting forward-rearward direction acceleration and lateral acceleration of the vehicle 100, respectively, an engine speed sensor for detecting rotational speed of the engine 1, a yaw rate sensor for detecting rotation angle speed around a vertical axis through center of gravity of the vehicle 100, and a throttle opening angle sensor for detecting opening angle of the throttle valve 1a (throttle opening angle). The internal sensor group 12 also includes sensors for detecting driver driving operations in manual drive mode, including, for example, accelerator pedal operations, brake pedal operations, steering wheel operations and the like.

The term input-output unit 13 is used herein as a collective designation encompassing apparatuses receiving instructions input by the driver and outputting information to the driver. The input-output unit 13 includes, inter alia, switches which the driver uses to input various instructions, a microphone which the driver uses to input voice instructions, a display for presenting information to the driver via displayed images, and a speaker for presenting information to the driver by voice. The switch of the input-output unit 13 includes a self/manual drive select switch for instructing a self-drive mode or manual drive mode.

The self/manual drive select switch, for example, is configured as a switch manually operable by the driver to output an instruction of switching to a self-drive mode enabling self-drive functions or a manual drive mode disabling self-drive functions in accordance with operation of the switch. Optionally, the self/manual drive select switch can be configured to instruct switching from manual drive mode to self-drive mode or from self-drive mode to manual drive mode when a predetermined condition is satisfied without operating the self/manual drive select switch. In other words, drive mode is switched automatically not manually by automatic switching of the self/manual drive select switch. Self-drive mode includes a normal self-drive mode for self-driving the vehicle 100 to a destination set by a driver or other occupant in advance and a disaster drive mode for immediately moving the vehicle 100 to a predetermined place different from the destination when disaster information is received.

The GPS unit 14 includes a GPS receiver (GPS sensor) for receiving position determination signals from multiple GPS satellites, and measures absolute position (latitude, longitude and the like) of the vehicle 100 based on the signals received from the GPS receiver. The measured position data of the vehicle 100 is sent to the server 50 through the communication unit 17.

The map database 15 is a unit storing general map data used by the navigation unit 16 and is, for example, implemented using a hard disk. The map data include road position data and road shape (curvature etc.) data, along with intersection and road branch position data. The map data stored in the map database 15 are different from high-accuracy map data stored in a memory unit 22 of the controller 20.

The navigation unit 16 retrieves target road routes to destinations input by the driver and performs guidance along selected target routes. Destination input and target route guidance is performed through the input-output unit 13. Target routes are computed based on current position of the vehicle 100 measured by the GPS unit 14 and map data stored in the map database 15. Destination can be automatically set by an instruction sent from the server 50, and thus in case of disaster, it is possible to move the vehicle 100 to evacuation place corresponding to disaster information.

The communication unit 17 communicates through the network 201 with the server 50 to acquire disaster information, etc. from the server 50. The communication unit 17 can acquire map data, traffic data and the like, periodically or at arbitrary times from various servers. Acquired map data are output to the map database 15 and/or memory unit 22 to update their stored map data. Acquired traffic data include congestion data and traffic light data including, for instance, time to change from red light to green light.

The actuators AC are actuators for operating various devices in relation to vehicle traveling, i.e., for traveling of the vehicle 100. The actuators AC include a throttle actuator for adjusting an opening angle of the throttle valve 1a of the engine 1 (throttle opening angle), an engine start actuator (starter motor 5), the motor-generator 2, a shift actuator (for example, a solenoid of control valve 6a) for changing speed stage of the transmission 3 by controlling flow of oil to the engaging mechanism 3a of the transmission 3, a brake actuator for operating a braking device, and a steering actuator for driving a steering unit.

The controller 20 is constituted by an electronic control unit (ECU). In FIG. 2, the controller 20 is integrally configured by consolidating multiple function-differentiated ECUs such as an engine control ECU, a transmission control ECU, a clutch control ECU and so on. Optionally, these ECUs can be individually provided. The controller 20 incorporates a computer including a CPU or other processing unit (a microprocessor) 21, the memory unit (a memory) 22 of RAM, ROM, hard disk and the like, and other peripheral circuits such as an input/output interface not shown in the drawings.

The memory unit 22 stores high-accuracy detailed map data including, inter alia, lane center position data and lane boundary line data. More specifically, road data, traffic regulation data, address data, facility data, and telephone number data. The road data include data identifying roads by type such as expressway, toll road and national highway, and data on, inter alia, number of road lanes, individual lane width, road gradient, road 3D coordinate position, lane curvature, lane merge and branch point positions, and road signs. The traffic regulation data include, inter alia, data on lanes subject to traffic restriction or closure owing to construction work and the like. The memory unit 22 also stores a shift map (shift chart) serving as a shift operation reference, various programs for performing processing, and threshold values used in the programs, etc.

As functional configurations in relation to self-driving, the processing unit 21 includes mainly a subject vehicle position recognition unit 23, an exterior recognition unit 24, an action plan generation unit 25, and a driving control unit 26.

The subject vehicle position recognition unit 23 recognizes map position of the vehicle (subject vehicle) 100 (subject vehicle position), based on position data of the vehicle 100 calculated by the GPS unit 14 and map data stored in the map database 15. Optionally, the subject vehicle position can be recognized using map data (building shape data and the like) stored in the memory unit 22 and ambience data of the vehicle 100 detected by the external sensor group 11, whereby the subject vehicle position can be recognized with high accuracy. Optionally, when the subject vehicle position can be measured by sensors installed externally on the road or by the roadside, the subject vehicle position can be recognized with high accuracy by communicating with such sensors through the communication unit 17.

The exterior recognition unit 24 recognizes external circumstances around the vehicle 100 based on signals from LIDARs, RADARs, cameras and the like of the external sensor group 11. For example, it recognizes position, speed and acceleration of nearby vehicles (forward vehicle or rearward vehicle) driving in the vicinity of the vehicle 100, position of vehicles stopped or parked in the vicinity of the vehicle 100, and position and state of other objects. Other objects include traffic signs, traffic lights, road boundary and stop lines, buildings, guardrails, power poles, commercial signs, pedestrians, bicycles, and the like. Recognized states of other objects include, for example, traffic light color (red, green or yellow) and moving speed and direction of pedestrians and bicycles.

The action plan generation unit 25 generates a driving path of the vehicle 100 (target path) from present time point to a certain time ahead based on, for example, a target route computed by the navigation unit 16, subject vehicle position recognized by the subject vehicle position recognition unit 23, and external circumstances recognized by the exterior recognition unit 24. When multiple paths are available on the target route as target path candidates, the action plan generation unit 25 selects from among them the path that optimally satisfies legal compliance, safe efficient driving and other criteria, and defines the selected path as the target path. The action plan generation unit 25 then generates an action plan matched to the generated target path. An action plan is also called “travel plan”.

The action plan includes action plan data set for every unit time Δt (e.g., 0.1 sec) between present time point and a predetermined time period T (e.g., 5 sec) ahead, i.e., includes action plan data set in association with every unit time Δt interval. The action plan data include subject vehicle position data and vehicle state data for every unit time Δt. The position data are, for example, target point data indicating 2D coordinate position on road, and the vehicle state data are vehicle speed data indicating vehicle speed, direction data indicating direction of the vehicle 100, and the like. Action plan is updated every unit time Δt.

The action plan generation unit 25 generates the target path by connecting position data at every unit time Δt between present time point and predetermined time period T1 ahead in time order. Further, the action plan generation unit 25 calculates acceleration (target acceleration) of sequential unit times Δt, based on vehicle speed (target vehicle speed) corresponding to target point data of sequential unit times Δt on target path. In other words, the action plan generation unit 25 calculates target vehicle speed and target acceleration. Optionally, the driving control unit 26 can calculate target acceleration.

In self-drive mode, the driving control unit 26 controls the actuators AC to move the vehicle 100 at target vehicle speed and target acceleration along target path generated by the action plan generation unit 25. Namely, the driving control unit 26 controls the throttle actuator, motor-generator 2, shift actuator, brake actuator and steering actuator so that the vehicle 100 travels through the target points of the unit times Δt.

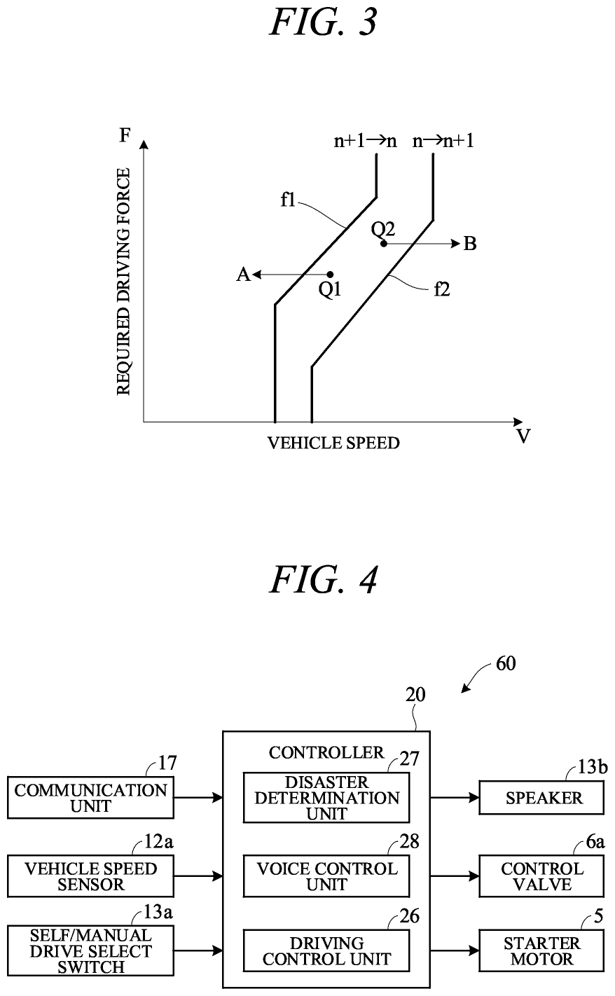

The shift actuator is controlled based on a shift map defined in advance. FIG. 3 is a diagram showing an example of the shift map stored in the memory unit 42 (FIG. 2). In the drawing, horizontal axis is scaled for vehicle speed V and vertical axis for required driving force F. Required driving force F is in one-to-one correspondence to accelerator opening angle which is an amount of operation of an accelerator (in self-drive mode, simulated accelerator opening angle) or throttle opening angle, and required driving force F increases with increasing accelerator opening angle or throttle opening angle. Therefore, the vertical axis can instead be scaled for accelerator opening angle or throttle opening angle. Characteristic curve f1 is an example of a downshift curve corresponding to downshift from n+1 stage to n stage and characteristic curve f2 is an example of an upshift curve corresponding to upshift from n stage to n+1 stage.

For example, considering downshift from operating point Q1 in FIG. 3, in a case where vehicle speed V decreases under constant required driving force F, the transmission 3 downshifts from n+1 stage to n stage when operating point Q1 crosses downshift curve (characteristic curve f1; arrow A). Also, in a case where required driving force F increases under constant vehicle speed V, the transmission 3 downshifts when operating point Q1 crosses downshift curve.

On the other hand, considering upshift from operating point Q2, in a case where vehicle speed V increases under constant required driving force F, the transmission 3 upshifts from n stage to n+1 stage when operating point Q2 crosses upshift curve (characteristic curve f2; arrow B). Also, in a case where required driving force F decreases under constant vehicle speed V, the transmission 3 upshifts when operating point Q1 crosses upshift curve. Downshift curves and upshift curves are shifted to high speed side along with an increase of speed stage.

The self-driving vehicle 100 according to the embodiment of the invention includes a vehicle control apparatus configured to evacuate the vehicle 100 to a safe place when receiving disaster information. FIG. 4 is a block diagram showing main configuration of this vehicle control apparatus 60. Although the vehicle control apparatus 60 includes a configuration in relation to self-driving, FIG. 4 shows omitting some of configurations of FIG. 2.

As shown in FIG. 4, the communication unit 17, vehicle speed sensor 12a, self/manual drive select switch 13a, speaker 13b, control valve 6a and starter motor 5 are connected to the controller 20. The self/manual drive select switch 13a is a switch for switching drive mode to self-drive mode or manual drive mode. For example, drive mode is switched to manual drive mode by operating a manual-drive select button arranged near the driver's seat, and is switched to self-drive mode by operating a self-drive select button arranged near the driver's seat. The vehicle speed sensor 12a is included in the internal sensor group 12. The self/manual drive select switch 13a and speaker 13b are included in the input-output unit 13. The controller 20 has a disaster determination unit 27, voice control unit 28 and driving control unit 26, as functional configurations.

The disaster determination unit 27 determines type of disaster information based on disaster information received through the communication unit 17. Specifically, it determines whether it is information regarding a disaster requiring evacuation to a suitable evacuation place (hereinafter sometimes called “evacuation-required disaster information”) or is disaster information requiring vehicle safety to be ensured by prompt stopping on a road shoulder (hereinafter sometimes called “safeguarding-required disaster information”). Received disaster information related to tsunami warning, volcanic eruption warning or heavy rain (flood) warning, for example, is defined evacuation-required disaster information, and received disaster information related to ballistic missile launch warning or earthquake warning is defined safeguarding-required disaster information.

The voice control unit 28 sends control signals to the speaker 13b to output a warning corresponding to disaster information received through the communication unit 17. Optionally, the voice control unit 28 can be adapted to accompany the output of the warning with an announcement from the speaker 13b notifying that unless the self/manual drive select switch 13a is operated, drive mode will be automatically switched to disaster drive mode after a predetermined time period.

Upon receiving disaster information through the communication unit 17, the driving control unit 26 outputs a control signal to the control valve 6a (actually to its solenoid) to downshift the transmission 3. More exactly, the driving control unit 26 uses a driving performance diagram representing relationship between vehicle speed and driving force in each speed stage, stored in the memory unit 22 in advance, to determine lowest speed stage corresponding to vehicle speed detected by the vehicle speed sensor 12a and downshifts by a number of stages with the determined lowest speed stage as the limit. Degree of downshifting is decided in accordance with difference between current speed stage and the lowest speed stage. For example, degree of downshifting is increased in proportion as the difference is greater. Optionally, the transmission 3 can be downshifted in accordance with the shift map of FIG. 3, for example, with required driving force at operating point Q1 increased by a certain amount or with the downshift characteristic curve f1 moved toward high-speed side by a certain amount. Since the downshifted transmission 3 can provide enhanced vehicle driving force, the vehicle 100 can be quickly accelerated.

In a case where, at time of receiving disaster information through the communication unit 17, the vehicle 100 is traveling solely on power from the motor-generator 2 with the engine 1 stopped, i.e., is traveling in EV mode, the driving control unit 26 outputs a control signal to the starter motor 5 to start the engine 1. Therefore, traveling of the vehicle 100 comes to be powered by both the engine 1 and the motor-generator 2, it travels in hybrid mode. As a result, greater vehicle driving force can be achieved.

In addition, the driving control unit 26 determines whether the self/manual drive select switch 13a has been operated within a predetermined time period after processing performed by the voice control unit 28 led to output of a warning from the speaker 13b, namely, whether either the self-drive select button or the manual-drive select button has been operated. When the driving control unit 26 determines that the self/manual drive select switch 13a has not been operated within the predetermined time period, namely, that neither the self-drive select button nor the manual-drive select button has been operated, it switches driving mode to disaster drive mode.

When the disaster determination unit 27 determines that the disaster information received at this time is evacuation-required disaster information, the driving control unit 26 sets destination of the vehicle 100 to the evacuation place received by the communication unit 17, i.e., to the evacuation place decided by the server 50 in accordance with type of disaster. The driving control unit 26 thereafter controls the actuators AC for traveling (FIG. 2) so that the vehicle 100 travels toward the set destination by self-driving. Since the transmission 3 has been downshifted in advance, driving force of the vehicle 100 can be promptly increased at this time to enable the vehicle 100 to proceed rapidly to the evacuation place.

On the other hand, when the disaster determination unit 27 determines that the received disaster information is safeguarding-required disaster information, the driving control unit 26 uses signals from the external sensor group 11 (cameras etc.) to detect a road shoulder site where the vehicle can be safely stopped and stops the vehicle 100 at the detected site. Since the transmission 3 has been downshifted in advance, the vehicle 100 can be promptly stopped on the shoulder utilizing engine braking.

When, within a predetermined time period after notification of a warning from the speaker 13b, the driver selects manual drive mode by operating the self/manual drive select switch 13a, drive mode is switched to manual drive mode (or manual drive mode is maintained if already in effect). In this state, the driving control unit 26 controls the actuators AC for traveling in accordance with driver operation of the accelerator pedal, brake pedal, steering wheel and so on.

Moreover, when the driver operates the self/manual drive select switch 13a to select self-drive mode within the predetermined time period after notification of a warning from the speaker 13b, drive mode is switched to self-drive mode (or self-drive mode is maintained if already in effect). In this state, the driving control unit 26 controls the actuators AC for traveling to autonomously drive the vehicle to a destination designated by the driver in advance.

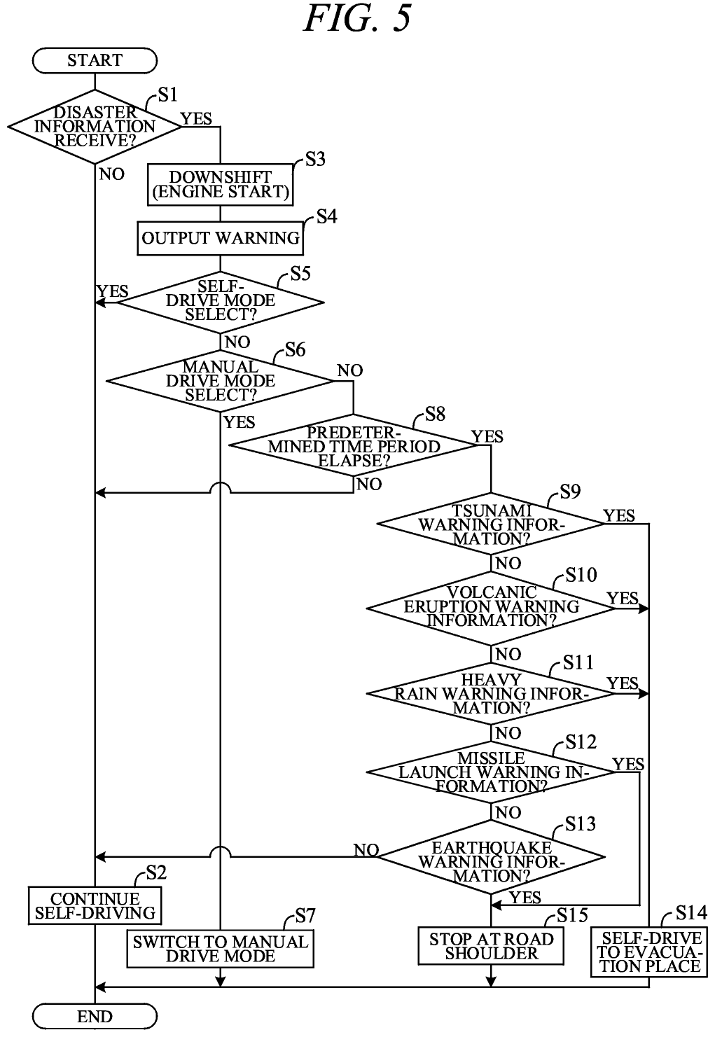

FIG. 5 is a flowchart showing an example of processing performed by the controller 20 of FIG. 4 in accordance with a predetermined program. The processing indicated in this flowchart is started, for example, when self-drive mode is selected by the self/manual drive select switch 13a and is repeatedly performed periodically at predetermined intervals.

First, in S1 (S: processing Step), whether disaster information (emergency information) has been received via the communication unit 17 is determined. If a negative decision is made in S1, the routine proceeds to S2 to continue self-driving in normal self-drive mode. In other words, in this case control signals are output to the actuators AC for traveling so that the vehicle 100 travels autonomously toward a destination decided by the occupant (driver) in advance. On the other hand, if a positive decision is made in S1, the routine proceeds to S3.

In S3, provided that lowest speed stage corresponding to vehicle speed detected by the vehicle speed sensor 12a has been determined, a control signal is output to the control valve 6a to downshift the transmission 3 in accordance with difference between current speed stage and the detected lowest speed stage. If the engine 1 is not starting at this time, it is started by sending a control signal to the starter motor 5. Next, in S4, a control signal is sent to the speaker 13b to output a warning corresponding to the disaster information received in S1. Then, in S5, whether self-drive mode has been selected by operation of the self/manual drive select switch 13a, i.e., whether the self-drive select button has been operated, is determined. If a positive decision is made in S5, the routine proceeds to S2, and if a negative decision is made, it proceeds to S6.

In S6, whether manual drive mode has been selected by operation of the self/manual drive select switch 13a, i.e., whether the manual-drive select button has been operated, is determined. If a positive decision is made in S6, the routine proceeds to S7 to switch drive mode to manual drive mode. In this case, control signals are output to the actuators AC for traveling in accordance with driver operation of the accelerator pedal, brake pedal and so on. On the other hand, if a negative decision is made in S6, the routine proceeds to S8. In S8, whether predetermined time period following output of the warning in S4 has passed with no operation of either the self-drive select button or the manual-drive select button is determined. If a positive decision is made in S8, the routine proceeds to S9, and if a negative decision is made, it proceeds to S2.

In S9, whether the disaster information received in S1 is tsunami warning information is determined. If a negative decision is made in S9, the routine proceeds to S10, in which whether the disaster information received in S1 is volcanic eruption warning information is determined. If a negative decision is made in S10, the routine proceeds to S11, in which whether the disaster information received in S1 is heavy rain warning information is determined. If a negative decision is made in S11, the routine proceeds to S12, in which whether the disaster information received in S1 is missile launch warning information is determined. If a negative decision is made in S12, the routine proceeds to S13, in which whether the disaster information received in S1 is earthquake warning information is determined. If a negative decision is made in S13, the routine proceeds to S2.

If a positive decision is made in any of S9, S10 and S11, i.e., when the disaster information is evacuation-required disaster information, the routine proceeds to S14. In 514, the evacuation place received by the communication unit 17, i.e., the evacuation place decided by the server 50 in accordance with the type of disaster, is set as the destination of the vehicle 100, and the actuators AC for traveling are controlled so that the vehicle 100 proceeds to the set destination. If a positive decision is made in either S12 or S13, i.e., when the disaster information is safeguarding-required disaster information, the routine proceeds to S15. In S15, a road shoulder site where the vehicle can be safely stopped is detected based on signals from the external sensor group 11, and the actuators AC for traveling are controlled to stop the vehicle 100 at the detected road shoulder site.

A more detailed explanation of self-driving vehicle 100 operation according to an embodiment of the present embodiment follows. When disaster information is received through the communication unit 17 during EV driving of the vehicle 100 in self-drive mode, for example, the transmission 3 downshifts and the engine 1 starts (S3). Moreover, a warning corresponding to the received disaster information is output from the speaker 13b (S4). When at this time the driver operates the self/manual drive select switch 13a to select manual drive mode within predetermined time period, drive mode is switched to manual mode (S7). The vehicle 100 therefore travels in accordance with driver operation of the accelerator pedal, brake pedal, steering wheel and so on. Once traveling in manual drive mode starts, the vehicle 100 can quickly run in response to driver operations because the transmission 3 has already downshifted and the engine 1 is starting (S3).

When the driver operates the self/manual drive select switch 13a to select self-drive mode within predetermined time period after output of the warning from the speaker 13b, self-drive mode is continued (S2). The vehicle 100 therefore continues to travel in self-drive mode toward the destination already set by the driver. In this case, too, the vehicle 100 can travel quickly because large vehicle driving force is available owing to the transmission 3 being already downshifted and the engine 1 running (S3).

So when the self/manual drive select switch 13a is operated within predetermined time period after output of a warning, the vehicle 100 travels in the drive mode corresponding to driver switch operation (manual drive mode or self-drive mode). The vehicle can therefore be made to travel as desired by the driver even during an emergency.

On the other hand, when the self/manual drive select switch 13a is not operated within predetermined time period after output of a warning from the speaker 13b, drive mode is switched to disaster drive mode. When the disaster information concerned is evacuation-required disaster information such as information related to tsunami warning, volcanic eruption warning, heavy rain warning or the like, rapid movement to a safe location on high ground, for example, is advisable. An evacuation place decided by the server 50 is therefore set as destination of the vehicle 100 and the vehicle autonomously drives toward this destination (S14). Since the transmission 3 downshifts and the engine 1 starts at the beginning of disaster drive mode implementation (S3), vehicle driving force can be increased to enable rapid movement of the vehicle 100 toward the evacuation place.

When the disaster information at the time of switching drive mode to disaster drive mode is ballistic missile launch warning information, earthquake warning information or other safeguarding-required disaster information, it is advisable for the vehicle to immediately stop at a safe place and for the occupant (driver) to evacuate the vehicle 100. Optionally, the occupant can remain inside the vehicle once parked on a shoulder of an expressway or the like. In view of these considerations, the onboard unit 101 is adapted to detect a safe road shoulder site, and the vehicle 100 is autonomously stopped at the detected shoulder site (S15). Since the transmission 3 downshifts and the engine 1 is starting at this time (S3), engine braking acts to ensure prompt stopping of the vehicle 100 on the shoulder.

The present embodiment can achieve advantages and effects such as the following:

(1) The self-driving vehicle 100 according to the present embodiment includes: the actuators AC used for traveling of the self-driving vehicle 100; the communication unit 17 for receiving disaster information; and the controller 20 responsive to disaster information being received by the communication unit 17 for controlling the actuators AC to evacuate the vehicle 100 at or to a road shoulder, evacuation place or other predetermined location (FIG. 2). The actuators AC include the shift actuators (the control valve 6a and the like) for shifting speed ratio of the transmission 3 installed in the power transmission path to transmit motive power of the engine 1 and the motor-generator 2 to the wheels 4, and the controller 20 is responsive to disaster information being received by the communication unit 17 for controlling the shift actuators to downshift the transmission 3, i.e., so as to increase speed ratio.

Therefore, the transmission 3 downshifts when a disaster occurs, and vehicle driving force of the self-driving vehicle 100 can be increased in response to disaster occurrence. Since this enhances acceleration performance and deceleration performance of the vehicle 100, the vehicle 100 can be rapidly evacuated to an evacuation place or safeguarded on a road shoulder or similar during an emergency.

(2) The self-driving vehicle 100 is configured as a hybrid vehicle having the engine 1 and the motor-generator 2 (FIG. 1). The actuators AC include the starter motor 5 for starting the engine 1 (FIG. 1). When the engine 1 is in inactive state, the controller 20 is responsive to disaster information being received by the communication unit 17 for controlling the starter motor 5 to additionally start the engine 1. Since traveling of the vehicle 100 is thereafter powered by both the engine 1 and the motor-generator 2 as power sources, driving force of the vehicle 100 is increased at time of disaster occurrence, thereby enabling rapid evacuation or safeguarding of the vehicle 100.

(3) The disaster information includes evacuation-required disaster information and safeguarding-required disaster information as two distinct types. The controller 20 is responsive to evacuation-required disaster information being received by the communication unit 17 for controlling the actuators AC so as to move the vehicle to a certain evacuation place, and is responsive to safeguarding-required disaster information being received by the communication unit 17 for controlling the actuators AC so as to stop the vehicle on a road shoulder. Since different destinations are set for different types of disaster in this manner, the occupant can be evacuated to or safeguarded at safe places decided in light of the nature of the disaster.

(4) The self-driving vehicle 100 further includes the speaker 13b for notifying the occupant of warnings when the communication unit 17 receives disaster information (FIG. 4). After a warning has been output by the speaker 13b, the controller 20 can switch drive mode from self-drive mode to manual drive mode in response to mode switching instructed by operation of the self/manual drive select switch 13a. Since self-drive mode can therefore be disabled by an occupant (driver) operation when a disaster occurs, traveling of the vehicle 100 matched to occupant preference can be achieved.

(5) The controller 20 automatically transitions to disaster drive mode when no mode switching instruction is output through the self/manual drive select switch 13a within predetermined time period after a warning has been announced through the speaker 13b. In other words, upon receiving disaster information, the vehicle 100 stands by in an immediate transition ready state for a certain time period (S3) so as to give the driver time to decide whether to select manual drive mode or self-drive mode. Since this ensures that driving is performed in line with driver preference, degree of driver satisfaction is high.

Various modifications of the aforesaid embodiment are possible. Some examples are explained in the following. In the aforesaid embodiment, the vehicle 100 is configured as a hybrid vehicle, and when the communication unit 17 receives disaster information, not only is the transmission 3 downshifted but the engine 1, if in inactive state, is also started. However, the controller 20 serving as a control unit (microprocessor) can be of any configuration insofar as adapted to control a shift actuator so as at least to increase speed ratio. In the aforesaid embodiment, the control valve 6a driven in proportion to current supplied to a solenoid is used as a shift actuator, but the speed ratio changing mechanism (transmission 3) can instead be driven by an electric motor. Therefore, a shift actuator is not limited to this configuration. Moreover, the engine 1 can be started by means other than the starter motor 5, and therefore, a start actuator is not limited to the aforesaid configuration.

In the aforesaid embodiment, the vehicle 100 is configured to be evacuated to a designated evacuation place when any of tsunami warning, volcanic eruption warning and heavy rain warning information is received as evacuation-required disaster information. However, types of a first disaster information are not limit to these. In the aforesaid embodiment, the vehicle 100 is configured to be stopped on a road shoulder or similar when either ballistic missile launch warning or earthquake warning information is received as safeguarding-required disaster information. However, the types of a second disaster information are not limit to these. In the aforesaid embodiment, a warning is notified through the speaker 13b when disaster information is received through the communication unit 17. However, warnings can instead be posted on a display, and therefore a warning unit is not limited to the aforesaid configuration. In the aforesaid embodiment, the self/manual drive select switch 13a serving as a drive mode instruction portion is configured to instruct either self-drive mode for driving the self-driving vehicle 100 to a destination by self-driving or manual drive mode for disabling self-drive capability of the self-driving vehicle 100 and driving the self-driving vehicle 100 by manual driving. However, a self-driving vehicle can alternatively be enabled to select drive mode from among, inter alia, eco mode for prioritizing fuel efficiency, sport mode for prioritizing power performance, and normal mode for striking a balance between power performance and fuel economy performance. Optionally in such case, drive mode can be changed to sport mode when disaster information is received. In the aforesaid embodiment, conditions around the self-driving vehicle 100 are detected by the external sensor group 11. However, as long as a road shoulder around the self-driving vehicle is detected, a detecting unit is not limited to this configuration.

The present invention can be also used as a control method of the self-driving vehicle controlling an actuator for driving the self-driving vehicle in accordance with disaster information.

The above embodiment can be combined as desired with one or more of the above modifications. The modifications can also be combined with one another.

According to the present invention, it is possible to immediately evacuate the self-driving vehicle to a predetermined place when a disaster occurs.

Above, while the present invention has been described with reference to the preferred embodiments thereof, it will be understood, by those skilled in the art, that various changes and modifications may be made thereto without departing from the scope of the appended claims.

What is claimed is:

1. A self-driving vehicle, comprising:
a drive power source;
a transmission installed in a power transmission path transmitting a torque from the drive power source to wheels;
an actuator used for traveling;
a communication unit configured to receive a disaster information; and
an electric control unit including a microprocessor and a memory connected to the microprocessor, wherein
the microprocessor is configured to perform
controlling the actuator so as to evacuate the self-driving vehicle to a predetermined place when the disaster information is received by the communication unit,
the actuator includes a shift actuator changing a speed ratio of the transmission, and
the microprocessor is configured to perform
the controlling including controlling the shift actuator so as to increase the speed ratio of the transmission when the disaster information is received by the communication unit.

2. The self-driving vehicle according to claim 1, wherein
the self-driving vehicle is a hybrid vehicle including an internal combustion engine and a motor serving as the drive power source,
the actuator includes a start actuator configured to start the internal combustion engine, and
the microprocessor is configured to perform
the controlling including further controlling the start actuator so as to start the internal combustion engine when the disaster information is received by the communication unit during an inactivation of the internal combustion engine.

3. The self-driving vehicle according to claim 1, wherein
the disaster information includes a first disaster information and a second disaster information of types different from each other,
the microprocessor is configured to perform
switching a drive mode to a disaster drive mode when one of the first disaster information and the second disaster information is received by the communication unit, and
the controlling including controlling the actuator in the disaster drive mode so as to move the self-driving vehicle to a predetermined evacuation place when the first disaster information is received by the communication unit, and so as to stop the self-driving vehicle at a predetermined road shoulder when the second disaster information is received by the communication unit.

4. The self-driving vehicle according to claim 3, further comprising
a drive mode instruction portion configured to instruct one of a self-drive mode in which the self-driving vehicle is traveled to a predetermined destination by self-driving with a self-driving capability being valid and a manual drive mode in which the self-driving vehicle is traveled by manual-driving with a self-driving capability being invalid, wherein
the microprocessor is configured to perform
the switching including switching the drive mode to the self-drive mode when the self-drive mode is instructed by the drive mode instruction portion after the disaster information is received by the communication unit, switching the drive mode to the manual drive mode when the manual drive mode is instructed by the drive mode instruction portion after the disaster information is received by the communication unit, and switching the drive mode to the disaster drive mode when none of the self-drive mode and the manual drive mode is instructed by the drive mode instruction portion after the disaster information is received by the communication unit.

5. The self-driving vehicle according to claim 4, further comprising
a warning unit configured to warn an occupant of the self-driving vehicle when the disaster information is received by the communication unit, wherein
the microprocessor is configured to perform
the switching including switching the drive mode to the disaster drive mode when a predetermined time elapses from being warned by the warning unit with none of the self-drive mode and manual drive mode being instructed.

6. The self-drive vehicle according to claim 3, wherein
the communication unit is configured to receive an information of the predetermined evacuation place in accordance with the first disaster information at a time of receiving of the first disaster information, and
the microprocessor is configured to perform
the controlling including controlling the actuator so as to move the self-driving vehicle to the predetermined evacuation place included in the information received by the communication unit when the first disaster information is received by the communication unit.

7. The self-drive vehicle according to claim 3, further comprising
a detecting portion configured to detect a road shoulder around the self-driving vehicle, wherein
the microprocessor is configured to perform
the controlling including controlling the actuator so as to stop the self-driving vehicle at the road shoulder detected by the detecting portion when the second disaster information is received by the communication unit.

8. The self-drive vehicle according to claim 1, wherein
the first disaster information includes at least one of a tsunami information, a volcanic eruption information and a heavy rain information, and the second disaster information includes at least one of a missile launch information and an earthquake information.

9. A control method of a self-driving vehicle, the self-driving vehicle including a drive power source, a transmission installed in a power transmission path transmitting a torque from the drive power source to wheels, and an actuator used for traveling,
the control method comprising:
receiving a disaster information; and
controlling the actuator so as to evacuate the self-driving vehicle to a predetermined place when the disaster information is received, wherein
the actuator includes a shift actuator changing a speed ratio of the transmission, and
the controlling includes controlling the shift actuator so as to increase the speed ratio of the transmission when the disaster information is received.

10. The control method according to claim 9, wherein
the self-driving vehicle is a hybrid vehicle including an internal combustion engine and a motor serving as the drive power source,
the actuator includes a start actuator configured to start the internal combustion engine, and
the controlling includes further controlling the start actuator so as to start the internal combustion engine when the disaster information is received during an inactivation of the internal combustion engine.

11. The control method according to claim 9, wherein
the disaster information includes a first disaster information and a second disaster information of types different from each other,
the control method further comprising
switching a drive mode to a disaster drive mode when one of the first disaster information and the second disaster information is received, wherein
the controlling includes controlling the actuator in the disaster drive mode so as to move the self-driving vehicle to a predetermined evacuation place when the first disaster information is received, and so as to stop the self-driving vehicle at a predetermined road shoulder when the second disaster information is received.

12. The control method according to claim 11, further comprising
instructing one of a self-drive mode in which the self-driving vehicle is traveled to a predetermined destination by self-driving with a self-driving capability being valid and a manual drive mode in which the self-driving vehicle is traveled by manual-driving with a self-driving capability being invalid, wherein
the switching includes switching the drive mode to the self-drive mode when the self-drive mode is instructed after the disaster information is received, switching the drive mode to the manual drive mode when the manual drive mode is instructed after the disaster information is received, and switching the drive mode to the disaster drive mode when none of the self-drive mode and the manual drive mode is instructed after the disaster information is received.

13. The control method according to claim 12, further comprising
warning an occupant of the self-driving vehicle when the disaster information is received, wherein
the switching includes switching the drive mode to the disaster drive mode when a predetermined time elapses from being warned with none of the self-drive mode and manual drive mode being instructed.

14. The control method according to claim 11, wherein
the receiving includes receiving an information of the predetermined evacuation place in accordance with the first disaster information at a time of receiving of the first disaster information, and
the controlling includes controlling the actuator so as to move the self-driving vehicle to the predetermined evacuation place included in the information received in the receiving when the first disaster information is received.

15. The control method according to claim 11, further comprising
detecting a road shoulder around the self-driving vehicle, wherein
the controlling includes controlling the actuator so as to stop the self-driving vehicle at the road shoulder detected in the detecting when the second disaster information is received.

16. The control method according to claim 9, wherein
the first disaster information includes at least one of a tsunami information, a volcanic eruption information and a heavy rain information, and the second disaster information includes at least one of a missile launch information and an earthquake information.
